(19) United States
(12) Patent Application Publication
(10) Pub. No.: US 2012/0092129 A1
(43) Pub. Date: Apr. 19, 2012

(54) METHOD TO TRACK VEHICLE KEY NEAR VEHICLE FOR SMART ENTRY

(75) Inventor: Brian K. Lickfelt, Powell, OH (US)

(73) Assignee: Honda Motor Co., Ltd., Tokyo (JP)

(21) Appl. No.: 12/907,198

(22) Filed: Oct. 19, 2010

(51) Int. Cl. G08B 29/00

(52) U.S. Cl. 340/5.72

(57) ABSTRACT

An entry system for a vehicle includes a fob, a transmitter on the vehicle, a receiver on the vehicle, a control unit on the vehicle, and a vehicle lock in communication with the control unit. The fob is configured to transmit fob signals and to receive vehicle signals. The transmitter is for transmitting the vehicle signals to the fob. The receiver is for receiving the fob signals from the fob. The control unit is in communication with the transmitter and the receiver. The control unit is configured to determine whether the fob is getting closer to or farther from the vehicle based on the fob signals received by the receiver. The vehicle lock locks or unlocks in response to the control unit determining that the fob is getting closer to or farther from the vehicle and that the fob is not located in a hysteresis zone, which is disposed between a proximal zone, which is closer to the vehicle, and an outer zone, which is farther from the vehicle.

### BACKGROUND

Smart entry and passive entry systems for vehicles currently use low frequency (“LF”) electromagnetic (“EM”) fields to search for a key fob for entry into the vehicle, starting of the vehicle, as well as locking and lockout protection for the vehicle. Many systems use an antenna to define a certain region for activity to take place. For example, a driver door area antenna generates a fob search for locking and unlocking, and an antenna inside the cabin searches for starting the vehicle and also preventing the driver from locking the fob in the car. Similar zones exist on the passenger side of the vehicle, in the trunk and also behind the vehicle for trunk access. This system requires many antennas to define each zone.

Some vehicles apply an LF polling strategy. Such a vehicle sends out periodic LF pulses from antennas mounted on the vehicle. If a fob is in the vicinity of the vehicle, a pre-authentication can take place, making the entry system response quicker for entry into the vehicle when an operator grabs the door handle. If the fob identification has already been authenticated as the driver approaches the vehicle, then the vehicle only has to send the unlock command when the vehicle detects the driver grabbing the door handle. Other entry systems send the LF field to authenticate the fob after the door handle is grabbed. If the operator is too fast, the authentication and unlock command may not take place in time for the door to be unlocked before the user pulls on the door handle. This requires the operator to pull a second time on the handle to open the door.

Some vehicles also apply a feature referred to as “walk away locking”. It is believed that in such a system when the door of the vehicle closes, an LF field search is performed inside the vehicle to ensure there are no fobs in the vehicle. A search can then be performed outside the vehicle to locate the fob outside the vehicle. If no fobs are in the car and the fob is outside the vehicle, the vehicle will automatically lock itself with no action by the operator or holder of the fob.

Received signal strength indication (“RSSI”) has been used to locate fobs with respect to a vehicle. The vehicle can include an electronic control unit (“ECU”) that can calculate the position of the fob based on the signal strength of responses to each LF request. Problems still exist in known smart entry and passive entry systems, and even with systems that employ RSSI technology.

### SUMMARY

An example of an entry system for a vehicle includes a fob, a transmitter on the vehicle, a receiver on the vehicle, a control unit on the vehicle, and a vehicle lock in communication with the control unit. The fob is configured to transmit fob signals and to receive vehicle signals. The transmitter is for transmitting the vehicle signals to the fob. The receiver is for receiving the fob signals from the fob. The control unit is in communication with the transmitter and the receiver. The control unit is configured to determine whether the fob is getting closer to or farther from the vehicle based on the fob signals received by the receiver. The vehicle lock locks or unlocks in response to the control unit determining that the fob is getting closer to or farther from the vehicle and that the fob is not located in a hysteresis zone, which is disposed between a proximal zone, which is closer to the vehicle, and an outer zone, which is farther from the vehicle.

A method for remotely controlling locks on a vehicle includes measuring signal strengths of signals received by or transmitted from a fob, determining whether the fob is getting closer to or farther from the vehicle based on the measured signal strengths, and determining in which zone among a plurality of zones the fob is located. The plurality of zones includes a proximal zone, a hysteresis zone, and an outer zone. The hysteresis zone is interposed between the proximal zone and the outer zone. The method for remotely controlling locks on the vehicle further includes operating a lock in response to receiving a respective fob signal from the fob by a receiver on the vehicle. Operating the lock includes at least one of unlocking the lock in response to receiving the respective fob signal after determining that the fob is getting closer to the vehicle and locking the lock in response to receiving the respective fob signal after determining that the fob is within the outer zone and that the fob is getting farther from the vehicle.

### BRIEF DESCRIPTION OF THE DRAWINGS

FIG. 1 is a schematic depiction of a passive entry system for a vehicle.

FIG. 2 is a flow diagram depicting an example of a method for remotely controlling locks on a vehicle.

### DETAILED DESCRIPTION

The descriptions and drawings herein are merely illustrative and various modifications and changes can be made in the components disclosed without departing from the scope of the appended claims. Moreover, various identified components of an entry system disclosed herein are merely terms of art that may vary from one manufacture to another and should not be deemed to limit the present disclosure.

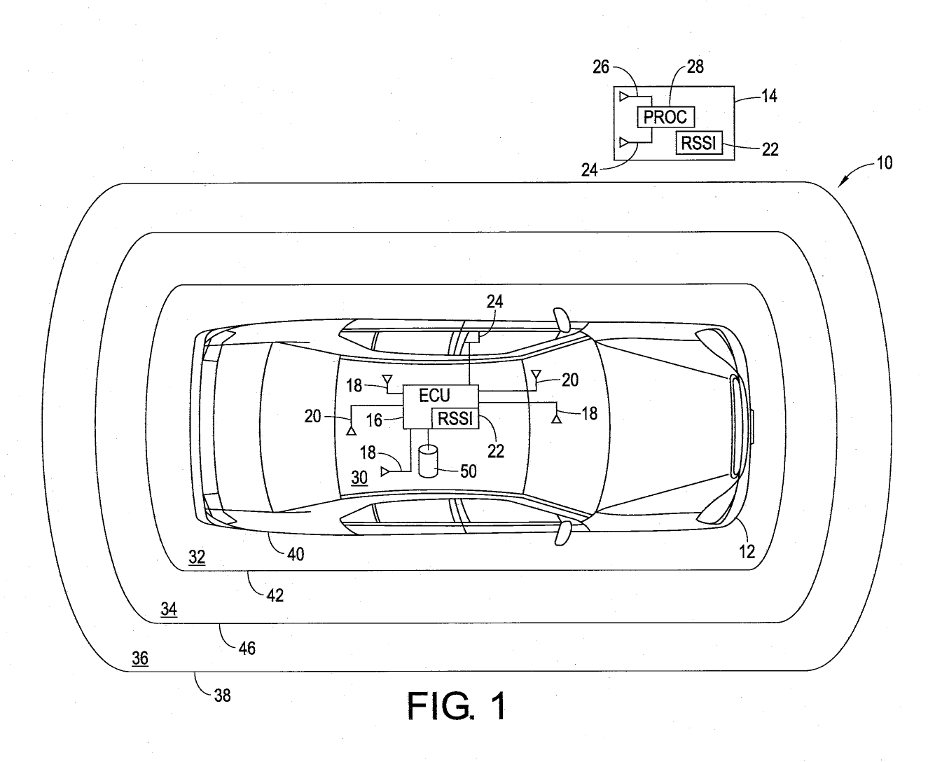

With reference to FIG. 1, a passive entry system 10 for a vehicle 12 includes a fob 14 that is configured to transmit and to receive signals. The entry system 10 further includes an ECU 16 on the vehicle 12. The ECU 16 is in communication with a transmitter 18 and a receiver 20. The transmitter 18 is also found on the vehicle and is for transmitting signals to the fob 14. For clarity purposes, signals transmitted from the fob 14 will be referred to as “fob signals” and signals transmitted from the transmitter 18 on the vehicle 12 will be referred to as “vehicle signals.” The receiver 20 is on the vehicle and is for receiving fob signals transmitted from the fob 20. Even though only three transmitters 18 and two receivers 20 are shown in FIG. 1, a fewer or a greater number of transmitters and/or receivers can be provided on the vehicle. Moreover, a plurality of transmitters and receivers can be beneficial when determining a location of the fob 14 with respect to the vehicle 12, which will be described in more detail below.

The system 10 is also configured to measure signal strengths of signals received from or received by the fob 14. As such, the system 10 can include an RSSI circuit 22 to measure signal strength of signals. The RSSI circuit 22 can be associated with the ECU 16 on the vehicle and/or the RSSI circuit 22 can be located in the fob 14.

In the illustrated embodiment, the fob 14 transmits radio frequency (“RF”) signals and receives LF EM signals. Accordingly, the fob 14 can include internal antennas 24, 26 and a processor 28 to receive and to transmit these signals. Alternatively, the fob 14 could transmit and receive other types of wireless signals, if desired. The fob 14, similar to known fobs, is typically small enough to be easily carried by an operator of the vehicle 12 and could be combined with or incorporated into other known devices such as a mobile phone or other small electronic device.

The ECU 16 is configured to determine whether the fob 14 is getting closer to or farther from the vehicle 12 based on the measured signal strengths. For example, where the transmitters 18 on the vehicle transmit LF signals, one of the antennas on the fob 14 receives this LF signal and the received LF signal is processed by the RSSI circuit 22 on the fob 14. The fob 14 can then transmit a fob signal to the receiver 20 on the vehicle 12 that includes signal strength data for the received vehicle signal. The RSSI circuit 22 on the fob 14 can measure the signal strength of vehicle signals sent from each transmitter 20 on the vehicle, e.g. a transmitter located near the trunk of the vehicle and a transmitter located near a passenger door of the vehicle. The fob signal, which is sent to the receiver 20 on the vehicle from the fob 14, can also include transmitter identification data, which is associated with the transmitter from which the vehicle signal was received. The ECU 16 on the vehicle 12 can calculate the fob position based on the signal strength data and the transmitter identification data. The ECU 16 can determine whether the fob 14 is getting closer to or farther from the vehicle 12 by comparing signal strength and transmitter identification data from earlier received signals to signal strength and transmitter identification data from later received signals.

LF RSSI analysis is typically more reliable than RF RSSI analysis, however, where the vehicle 12 includes the RSSI circuit 22, the RSSI circuit 22 can be used to measure signal strengths of fob signals received from the fob 14 by the receiver 20. The ECU 16 can determine whether the fob 14 is getting closer to or farther from the vehicle 12 by comparing signal strengths from earlier received fob signals to signal strengths from later fob received signals. Which receiver 20 that receives each respective fob signal can also be used to determine whether the fob 14 is getting closer to or farther from the vehicle 12.

The entry system 10 also includes a lock 24 that is in communication with the ECU 16. Only one vehicle door lock 24 is depicted in FIG. 1; however, a plurality of door locks, as well as a trunk lock or other closure lock, can be provided. The door lock 24 is an electronic door lock and can be similar to known door locks; however, the door lock operates in a manner that will be described in more detail below.

The entry system 10 is configured to define a plurality of zones with respect to the vehicle 12. These zones can include an internal zone 30, a proximal zone 32, a hysteresis zone 34, and an outer zone 36. The internal zone 30 is defined by the external boundary 40 of the vehicle 12, which is typically the outer surface of the vehicle body. If it is determined that the fob 14 is located in the internal zone 30, then it is assumed the fob 14 is located within the vehicle, e.g. within the cabin or the trunk of the vehicle. The proximal zone 32 is the zone closest to the vehicle 12, but located outside of or external to the vehicle. The outer zone 36 is defined at its outer limit 38 by the range of the signals sent from the transmitter 18 that can be detected by the fob 14 or by an outer limit in which the fob 14 can send detectible signals to the receiver 20. The hysteresis zone 34 is interposed between the proximal zone 32 and the outer zone 36. The proximal zone 32 and the hysteresis zone 34 share a common proximal/hysteresis boundary 42, which can be located about 1 meter from an external boundary 40 of the vehicle 12. The outer zone 36 and the hysteresis zone 34 share a common outer/hysteresis boundary 46. The size and shape of the zones depicted in FIG. 1 is merely illustrative and is not drawn to scale.

The ECU 16, as mentioned above, is configured to determine whether the fob 14 is getting closer to or farther from the vehicle 12 based on signals received from the fob. As mentioned above, more than one transmitter 18 and receiver 20 can be located on the vehicle 12. Where the RSSI circuit 22 is on the vehicle 12, each receiver 20 can receive a respective fob signal and the RSSI circuit 22 can determine the signal strength of the respective fob signal received from the fob to determine a location of the fob by, for example, triangulation. Where the RSSI circuit 22 is on the fob, each transmitter 18 can transmit a respective vehicle signal and the RSSI circuit 22 can determine the signal strength of the respective vehicle signals. This data, e.g. signal strength and transmitter identity, can be sent back to the ECU 16 to determine a location of the fob 14 by, for example, triangulation

The vehicle door lock 24 locks or unlocks in response to the ECU 16 determining that the fob 14 is getting closer to or farther from the vehicle 12 and that the fob is not located in the hysteresis zone 34. The hysteresis zone 34 is disposed between the proximal zone 32, which is closer to the vehicle 12, and the outer zone 36, which is farther from the vehicle. The ECU 16 is also configured to store distance data for each signal received from the fob 14. The distance data is associated with a distance that the fob 14 is spaced from the vehicle 12. The distance data can be associated with when a respective fob signal was sent from the fob or when a respective vehicle signal was received by the fob. Since the signals travel so quickly and the data is processed so quickly, basing the location of the fob 14 on a signal received by the fob or a signal sent from the fob should not lead to a large discrepancy between the determined position of the fob and the actual position of the fob. The ECU 16 is also configured to determine a location of the fob 14 within one of the plurality of zones, for example, as within the external zone 36, the hysteresis zone 34, the proximal zone 32, or the internal zone 30 based on the distance data. The ECU 16 is further configured to store zone data, which is associated with the zone in which the fob 14 is located.

For example, when an operator approaches the vehicle 12 carrying the fob 14, the ECU 16 polls for the fob by transmitting LF signals. An RF fob signal is transmitted from the fob 14 to the receiver 20 in reply to the polling signal when the fob enters within a range to receive the polling signal. When an operator of the vehicle 12 is approaching the vehicle 12, the initial FOB signal received by the receiver 20 is typically from the fob 14 located within the outer zone 36. The location of the fob 14 can be determined by measuring the strength of the polling signal received by the fob in the RSSI circuit 22 on the fob or by measuring the strength of the fob signal sent in reply to the polling signal in the RSSI circuit 22 on the vehicle 12. The ECU 16 stores data associated with the signals in a memory 50 associated with the ECU 16. The ECU 16 continues to poll for the fob 14 after receiving the initial fob signal and a subsequent fob signal is transmitted from the fob 14 to the receiver 20 in response to the subsequent polling signal from the transmitter 18. The strength of the subsequent fob signal or the strength of the subsequent polling signal is then measured in the RSSI circuit 22, either in the fob 14 or on the vehicle 12, and the data for the subsequent signal is also stored in the database 50.

The ECU 16 can now determine whether the fob 14 is getting closer to or farther from the vehicle 12 based on comparing the data associated with the initial signal (fob or polling signal) compared to the data associated with the subsequent signal (fob or polling). The zone in which the fob 14 is located can be determined based on the signal strength of the respective signals and triangulation by knowing the respective transmitter that initiated the polling signal or the respective receiver that received the fob signal. This zone data can also be stored in the memory 50. If the signal strength of the subsequent signal (fob or polling signal) is greater than the signal strength of the initial signal, then it can be deduced that the fob 14 is getting closer to the vehicle 12.

The lock 24 unlocks upon receiving a fob signal by the receiver 20 after determining that the fob 14 is getting closer to the vehicle 12 and the fob is within the proximal zone 32. The lock 24 remains unlocked after receiving a subsequent fob signal and determining that the fob 14 is within the hysteresis zone 34 when a fob signal immediately preceding the subsequent fob signal was received from the fob 14 when the fob 14 was within the proximal zone 32. As an example, if an operator carrying a fob approached a vehicle having only a proximal zone and an outer zone, i.e. no hysteresis zone, and the operator were to stop adjacent the proximal/outer boundary, the locks on such a vehicle could cycle between locking and unlocking where the operator carrying the fob moves back and forth between the proximal zone and the outer zone. By having the lock 24 remain unlocked after receiving a subsequent fob signal from within the hysteresis zone 34 when a signal immediately preceding the subsequent fob signal was received from the fob when the fob was in the proximal zone 32, the cycling between lock and unlock does not occur.

The passive entry system 10 can also automatically lock the door locks 24 upon receiving a subsequent fob signal and determining that the fob 14 is within the external zone 36 when a fob signal immediately preceding the subsequent fob signal was received from the fob 14 when the fob was within the vehicle, i.e. within the internal zone 30, or when the fob was in the proximal zone 32 or the hysteresis zone 34. Accordingly, the lock 24 can automatically lock when an operator of the vehicle walks away from the vehicle 12. The lock 24 can lock upon receiving a respective fob signal by the receiver after determining the fob is getting further from the vehicle 12 and the fob 14 is located within the external zone 36. By providing the hysteresis zone 34 cycling between locking and unlocking of the door lock 24 is mitigated.

For example, when an operator gets out of the vehicle 12 and walks away from the vehicle, the ECU 16 polls for the fob 14. The door lock 24 remains unlocked in response to reply signals received from the fob 14 when the fob is within the proximal zone 32 and the hysteresis zone 34. If it is determined that the fob 14 is getting farther from the vehicle and the latest reply signal received from fob is where the fob is within the outer zone 36, then the lock 24 locks. After the lock 24 locks, the lock will not unlock until it is determined that the fob 14 is getting closer to the vehicle and the reply signal triggering the unlock event is received from the fob 14 where the fob is located within the proximal zone 32. Accordingly, if an operator of the vehicle 12 is standing adjacent the outer/hysteresis boundary 46, the door locks 24 do not cycle between locking and unlocking. Such a configuration reduces the likelihood of the door lock 24 cycling between lock and unlock in an undesirable manner.

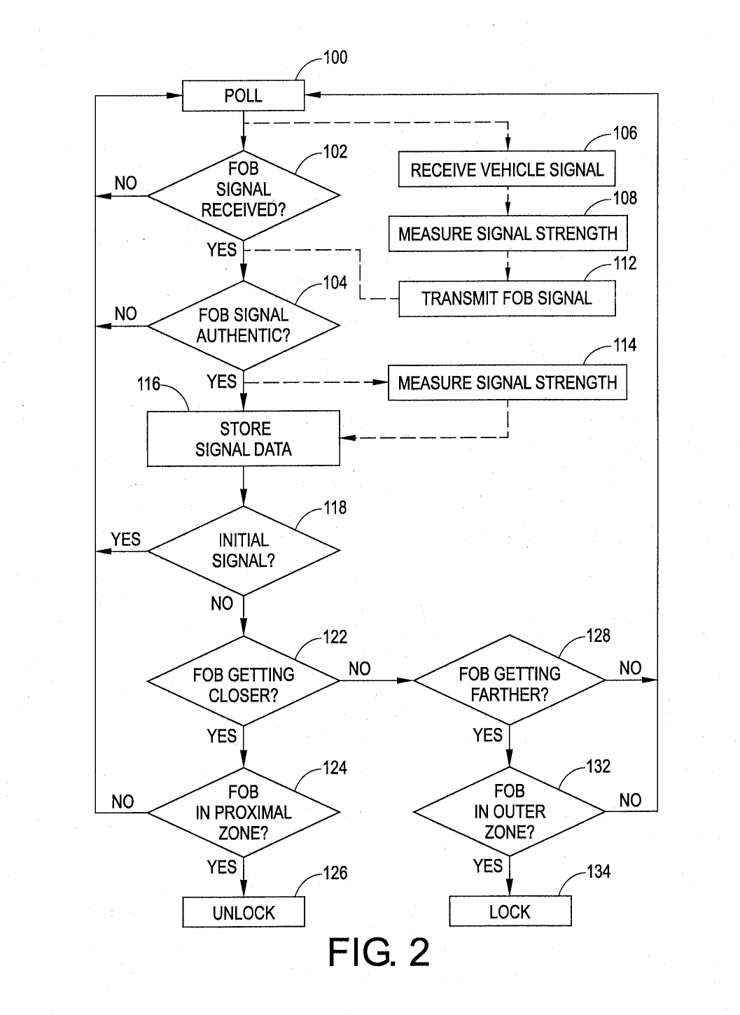

A method for remotely controlling locks on a vehicle will be described with reference to FIGS. 1 and 2. Even though the method will be described with reference to components shown in FIG. 1, the method described with reference to FIG. 2 could be used with other passive entry systems.

At 100, the ECU 16 (FIG. 1) polls for fobs, such as the fob 14. At 102, a determination is made as to whether a reply signal is received from a fob. If no reply signal is received, at 102, the algorithm reverts to 100 and continues to poll for fobs. If a reply signal is received at 102, then at 104, a determination is made as to whether the reply signal is authentic. More than one fob may transmit reply signals in response to the polling signal transmitted from the receiver 20. Only fobs associated with the vehicle 12 can unlock the door lock 24 (and perform other vehicle operations). Accordingly, if the reply signal received by the receiver 20 is determined to be not authentic, at 104, then the ECU 16 continues to poll for fobs that are associated with the vehicle 12.

Steps 100, 102 and 104 are performed on the vehicle 12. The fob 14 can receive the polling signal, at 106. The polling signal is transmitted from one of the transmitters 18 on the vehicle 12, and therefore, can be referred to as a vehicle signal. After receiving the polling signal, the fob 14 can measure the signal strength of the polling signal at 108. As discussed above, the fob 14 can include the RSSI circuit 22 for measuring the strength of the polling signal. At 112, the fob 14 can transmit the fob signal to the receiver 20 and the fob signal can include signal strength data associated with the polling signal that was received by the fob and the fob signal can further include transmitter identification data identifying the transmitter 18 on the vehicle 12 that transmitted the respective polling signal.

With reference back to the vehicle 12, if the fob signal is determined to be authentic, at 104, then at 114, the strength of the fob signal can be measured in the RSSI circuit 22 on the vehicle 12. At 116, signal data, such as the signal strength data and the zone data (each described above), are stored in the database 50. The ECU 16 is configured to determine whether the fob 14 is getting closer to or farther from the vehicle 12 and, therefore, at 118, a determination is made as to whether the reply signal that was sent from the fob 14 to the receiver 20 is an initial signal. If it is determined that the signal received from the fob 14 is an initial signal, at 118, then the ECU is unable to determine whether the fob is getting closer to or farther from the vehicle, and therefore, the algorithm reverts back to polling for the fob at 100. If, however, the respective reply signal received from the fob 14 by the receiver 20 is not an initial signal, then a determination is made, at 122, as to whether the fob 14 is getting closer to the vehicle 12. As discussed above, the ECU 16 can determine whether the fob 14 is getting closer to the vehicle, at 122, by comparing the strength of a subsequent vehicle or fob signal to the strength of a preceding vehicle or fob signal. At 124, a determination is made as to whether the fob 14 is located within the proximal zone 32. If it is determined that both the fob 14 is getting closer to the vehicle, at 122, and that the last signal sent from the fob 14 to the receiver 20 was sent with the fob located within the proximal zone 34, at 124, then the lock 24 unlocks at 126. If, however, the last signal sent from the fob 14 was with the fob not located within the proximal zone 34, i.e. the fob 14 was located in the hysteresis zone 34 or the outer zone 36, then the algorithm reverts back to polling for the fob at 100.

If it is determined that the fob 14 is not getting closer to the vehicle 12, at 122, then a determination is made as to whether the fob is getting farther from the vehicle, at 128. As discussed above, the ECU 16 can determine whether the fob 14 is getting farther from the vehicle 12 by comparing the signal strength of a subsequent vehicle or fob signal to the signal strength of a preceding vehicle or fob signal. If the signal strength of a subsequent signal is less than the signal strength of a preceding signal, then it can be deduced that the fob 14 is getting farther from the vehicle 12. If it is determined that the fob 14 is not getting farther from the vehicle, at 128, then the algorithm reverts back to polling for the fob at 100. If it is determined that the fob 14 is getting farther from the vehicle 12, at 128, then a determination is made as to whether the last signal sent from the fob 14 was when the fob was within the outer zone 36, at 132. If the last signal sent from the fob 14 was determined, at 132, to be from when the fob was located within the outer zone 36, then the door locks at 134. If it is determined that the last signal sent from the fob 14 was when the fob was not within the outer zone 36, i.e., the fob was within the hysteresis zone 34, the proximal zone 32 or within the internal zone 30, then the algorithm reverts back to polling for the fob at 100.

Accordingly, the method for remotely controlling locks on a vehicle 12 can include measuring signal strengths of signals received by or from the fob 14. This is shown at 108 and 144, respectively, in FIG. 2. The method for remotely controlling door locks can further include determining whether the fob is getting closer to (step 122) or farther from (step 128) the vehicle 12 based on the measured signal strengths. The method can further include determining in which zone, among a plurality of zones, the fob is located when the fob is transmitting each signal, which is shown at 124 and 132. As mentioned above, the plurality of zones includes the outer zone 36, the hysteresis zone 34, the proximal zone 32, and the internal zone 30.

The method for remotely controlling locks can further include operating the door lock 24 in response to a respective reply signal received from the fob 14. Operating the door lock 24 can include at least one of unlocking the door lock 24 in response to receiving the respective reply signal from the fob 14 from within the internal zone 32 after determining that the fob is getting closer to the vehicle 12 and locking the door lock 24 in response to receiving the respective reply signal from the fob 14 from within the external zone 36 after determining the fob is getting farther from the vehicle.

The method for remotely controlling door locks 24 on the vehicle 12 can further include storing distance data for each signal received from the fob 14. This is shown at 116 in FIG. 2, and the distance data can be stored in the database 50 (FIG. 1). The method for remotely controlling door locks 24 on the vehicle 12 can further include storing zone data for each signal received from the fob 14. The zone data can be stored in the database 50 and is associated with the zone in which the fob 14 was located when the respective signal was sent from the fob. The zone data can be determined based on the measured signal strength and the boundaries of the zones, which can be defined by predetermined distances from the vehicle and coordinates defining zones with respect to the vehicle. For example, the proximal/hysteresis boundary 42, which is the outer boundary of the proximal zone 32, can be about 1 meter from the external boundary 40 of the vehicle 12. The outer boundary of the hysteresis zone 34, i.e. the outer/hysteresis boundary 46, can be located about 3-5 meters from the vehicle 12. The outer boundary 38 of the outer zone 36 can be about 5-7 meters from the vehicle.

As discussed above, determining whether the fob 14 is getting closer to or farther from the vehicle 12 is based on the measured signal strengths as determined in the RSSI circuit 22, which can be associated with the ECU 16 in the vehicle 12 or found in the fob 14. The method could further include keeping the door lock 24 in whichever state, locked or unlocked, that the door lock is currently in in response to signals received from the fob when the fob is in the hysteresis zone 34. Accordingly, any signals received from the fob 14 when the fob is within the hysteresis zone 34 do not change the state of the locks. This reduces the likelihood of the lock 24 cycling between lock and unlock, which can be undesirable.

A passive entry system and a method for remotely controlling door locks on a vehicle has been described with particularity. Modifications and alterations will occur to those upon reading and understanding the preceding detailed description. The appended claims are not limited to only the embodiments described above. Instead, the invention is broadly defined by the appended claims and the equivalents thereof.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. An entry system for a vehicle comprising:
a fob configured to transmit fob signals and to receive vehicle signals;
a transmitter on the vehicle for transmitting the vehicle signals to the fob;
a receiver on the vehicle for receiving the fob signals from the fob;
a control unit on the vehicle and in communication with the transmitter and the receiver, the control unit being configured to determine whether the fob is getting closer to or farther from the vehicle based on the fob signals received by the receiver; and
a vehicle lock in communication with the control unit, wherein the vehicle lock locks or unlocks in response to the control unit determining that the fob is getting closer to or farther from the vehicle and that the fob is not located in a hysteresis zone, which is disposed between a proximal zone, which is closer to the vehicle, and an outer zone, which is farther from the vehicle.

2. The system of claim 1, further comprising an RSSI circuit in the fob for measuring signal strength of the vehicle signals received by the fob, wherein respective fob signals include signal strength data associated with a respective vehicle signal received by the fob, wherein the control unit calculates a fob position based on the signal strength data.

3. The system of claim 2, wherein the transmitter includes a plurality of transmitters and the RSSI circuit measures the signal strength of vehicle signals sent from respective transmitters, wherein respective fob signals include signal strength data for respective vehicle signals and transmitter identification data associated with the respective transmitter transmitting the respective vehicle signal, wherein the control unit calculates the fob position based on the signal strength data and the transmitter identification data.

4. The system of claim 1, wherein the control unit is configured to store distance data for each fob signal, wherein the distance data is associated with a distance that the fob was spaced from the vehicle when a respective fob signal was sent from the fob or the distance that the fob was spaced from the vehicle when the fob received a respective vehicle signal.

5. The system of claim 4, wherein the control unit is configured to determine a location of the fob as within the outer zone, the hysteresis zone or the proximal zone based on the distance data.

6. The system of claim 5, wherein the control unit is configured to store zone data, which is associated with the zone in which the fob was located when the respective fob signal was sent by the fob or when the respective vehicle signal was received by the fob.

7. The system of claim 5, wherein the lock unlocks upon receiving a respective fob signal after determining that the fob is getting closer to the vehicle and the fob is within the proximal zone.

8. The system of claim 5, wherein the lock remains unlocked after receiving a subsequent fob signal and determining that the fob is within the hysteresis zone when a signal immediately preceding the subsequent signal was received from the fob when the fob was within the proximal zone.

9. The system of claim 5, wherein the lock locks upon receiving a subsequent fob signal from the fob and the fob is determined to be within the outer zone when a signal immediately preceding the subsequent signal was received from the fob when the fob was within the vehicle, the proximal zone or the hysteresis zone.

10. The system of claim 5, wherein the lock locks upon receiving a respective signal from the fob after determining that the fob is getting farther from the vehicle and the respective signal was sent from the fob when the fob was within the outer zone.

11. A method for remotely controlling locks on a vehicle, the method comprising:
measuring signal strengths of signals received by or transmitted from a fob;
determining whether the fob is getting closer to or farther from the vehicle based on the measured signal strengths;
determining in which zone among a plurality of zones the fob is located, wherein the plurality of zones includes an outer zone, a hysteresis zone, and a proximal zone, wherein the hysteresis zone is interposed between the proximal zone and the outer zone;
operating a lock in response to receiving a respective fob signal by the transmitter, including at least one of unlocking the lock in response to receiving the respective fob signal after determining that the fob is within the proximal zone and that the fob is getting closer to the vehicle, and locking the lock in response to receiving the respective fob signal after determining that the fob is within the outer zone and that the fob is getting farther from the vehicle.

12. The method of claim 11, wherein determining in which zone the fob is located includes determining a location the fob with respect to the vehicle based on the measured signal strength of vehicle signals received by the fob and comparing the determined location to coordinates defining the zones with respect to the vehicle.

13. The method of claim 12, further comprising transmitting fob signals to the vehicle, wherein the fob signals include signal strength data for respective vehicle signals received by the fob, and determining in which zone the fob is located is performed in a control unit on the vehicle based on the signal strength data received from the fob.

14. The method of claim 11, further comprising:
storing distance data for signals received by or from the fob, wherein the distance data is associated with a distance that the fob was spaced from the vehicle when a respective fob signal was sent from the fob or the distance that the fob was spaced from the vehicle when the fob received a respective vehicle signal.

15. The method of claim 11, further comprising:
storing zone data associated with the zone in which the fob was located when the respective fob signal was sent from the fob or the zone in which the fob was located when the fob received the respective vehicle signal.

16. The method of claim 12, wherein determining whether the fob is getting closer to or farther from the vehicle based on the measured signal strengths further includes comparing a subsequent signal strength associated with a subsequent signal to a previous signal strength associated with a previous signal.

17. The method of claim 11, further comprising:
keeping the lock in whichever state, locked or unlocked, that the lock is currently in in response to signals received from the fob when it is determined that the fob is in the hysteresis zone.

18. The method of claim 11, wherein measuring signal strengths includes processing received LF vehicle signals in an RSSI circuit in the fob for each LF signal received from respective transmitters on the vehicle.

19. The method of claim 18, wherein determining in which zone the fob is located further includes determining a location for the fob based on the measured signal strength of vehicle signals received by the fob and which transmitter transmitted the respective vehicle signal.
